(19) United States
(12) Patent Application Publication
(10) Pub. No.: US 2025/0128399 A1
(43) Pub. Date: Apr. 24, 2025

(54) HANGER SYSTEM FOR PAINTLESS DENT REPAIR TOOLS AND METHOD FOR SECURING PAINTLESS DENT REPAIR TOOLS

(71) Applicant: DENT MEDIC OF SOUTHERN INDIANA, BOONVILLE, IN (US)

(72) Inventor: JESSE VIRGIN, BOONVILLE, IN (US)

(21) Appl. No.: 18/493,185

(22) Filed: Oct. 24, 2023

(51) Int. Cl. B25H 3/04

(52) U.S. Cl. CPC B25H 3/04; A47F 5/0838; A47F 7/0028

(57) ABSTRACT

A hanger system for dent repair tools is provided comprising an elongated support bar, at least one hanger element, and securing means for securing the hanger element to the elongated support bar. The elongated support bar has at least a first end affixed to a tool cart. Each of the at least one hanger elements has tool engaging means for removably receiving and securing a paintless dent repair tool by frictionally engaging a head of the paintless dent repair tool. The securing means are provided for removably securing the at least one hanger element to the elongated support bar. A method for securing a paintless dent repair tool in a hanger system for dent repair tools is also provided.

### BACKGROUND OF THE INVENTION

### Field of the Invention

This disclosure relates generally to a system for hanging tools for storage, and more particularly to a hanger system for dent repair tools.

### Description of the Related Art

Paintless Dent Removal (PDR) is a process that removes dents and dings from a vehicle. Special tools are used to push the metal back into its original shape from behind the dent. The metal around the outside edge of the dent is slowly manipulated back into its original position. The technician works from the outside in to make the dent smaller. An experienced technician can often times reduce the dent so much that it blends with the texture of the paint and almost completely disappears.

Several different tools are often times required to remove dents using PDR. Where mobile service is provided, PDR tools, which often times include an elongated shaft, are stored by hanging them on the side of a mobile TDN tool cart. The racks that are currently available for storing these PDR tools on a TDN tool cart do not completely secure the tools in place allowing them to swing back and forth clanging against each other. This makes a lot of unwanted noise and potentially causes damage to the tools, cart, and surrounding environment. The currently available PDR racks also require the PDR tool to be threaded through an opening into the tool holder. Where clearance above the cart is a concern, such as when the cart is in a vehicle such as a van, it can be difficult or impossible to get the PDR tool into or out of the tool holder.

Accordingly, there is a need for a hanger system for paintless dent removal tools that secures the tools in place preventing them from banging into one another during transport. There is also a need for a hanger system and method that allows the paintless dent removal tool to be quickly and easily inserted into and removed from the tool hanger.

### SUMMARY OF THE INVENTION

It is therefore an object of the present invention to provide a hanger system for paintless dent removal tools that secures the tools in place preventing them from banging into one another during transport.

It is also an object of the invention to provide a hanger system and method that allows the paintless dent removal tool to be quickly and easily inserted into and removed from the tool hanger.

The present invention meets these objects by providing a hanger system for paintless dent removal tools that securely engages the head of a paintless dent removal tool thereby securing it in place. The invention further meets these objects by providing a tool holder with an opening in the front face that allows the shaft of the tool to be inserted and removed from the holder without threading the entire shaft through an opening.

According to one presently preferred embodiment of the invention, there is provided a hanger system for dent repair tools comprising an elongated support bar, at least one hanger element, and securing means for securing the hanger element to the elongated support bar. The elongated support bar has at least a first end affixed to a tool cart. Each of the at least one hanger elements have tool engaging means for removably receiving and securing a paintless dent repair tool by frictionally engaging a head of the paintless dent repair tool. The securing means are provided for removably securing the at least one hanger element to the elongated support bar.

The securing means may further comprise an opening extending through a body of the hanger element proximate to a rear end thereof. The opening may be sized to slidably engage an outer surface of the elongated support bar. A plurality of hanger elements may be slidably positioned on the elongated support bar. The tool engaging means comprises a substantially cylindrical sleeve located at a front end of the body of said hanger element, said substantially cylindrical sleeve being substantially perpendicular to the support bar opening and having an opening from a top end to a bottom end of the body for receiving a paintless dent repair tool. A shoulder extending inwardly into the substantially cylindrical sleeve proximate to a bottom end of the body of the hanger element may also be provided.

According to a further aspect of the invention there is provided hanger system for dent repair tools comprising an elongated support bar having at least a first end affixed to a tool cart; and at least one hanger element. Each hanger element has a body with a front end and a rear end. Each hanger element has a support bar opening extending through the body proximate to the rear end of the body, and a substantially cylindrical sleeve located at the front end of the body. The substantially cylindrical sleeve is substantially perpendicular to the support bar opening and has an opening from a top end to a bottom end of the body. A shoulder extending inwardly into the substantially cylindrical sleeve proximate to the bottom end of the body is also provided.

A plurality of hanger elements are preferably provided and slidably positioned on the elongated support bar. The support bar has a square cross-section and the support bar opening is square in shape and corresponds to the cross-section of the support bar in size and shape. The hanger element is preferably formed from a plastic material selected from a group consisting of polypropylene, polyurethane, and PVC.

A further aspect of the present invention is a method for securing a paintless dent repair tool in a hanger system for dent repair tools. First the paintless dent repair tool is positioned in front of a front end of a hanger element with a head of the paintless dent repair tool being positioned above a top surface of the hanger element. Next, a shaft of the paintless dent repair tool is passed through an opening in the front end of the hanger element into a substantially cylindrical sleeve extending from the top surface of the hanger element to a bottom surface of the hanger element. The head of the paintless dent repair tool is then pulled into the substantially cylindrical sleeve such that an outer surface of the head frictionally engages the surface of the substantially cylindrical sleeve to securely hold the paintless dent repair tool in place. A further step of the method includes continuing to pull the head of the paintless dent repair tool into the substantially cylindrical sleeve until a portion of the head engages a shoulder extending inwardly into the substantially cylindrical sleeve proximate to the bottom end of the hanger element.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a front view in elevation of the hanger system for dent repair tools according to a presently preferred embodiment of the invention.

FIG. 2 is a front-side perspective view of a hanger element of the hanger system shown in FIG. 1.

FIG. 3 is a front-center perspective view of the hanger element shown in FIG. 2.

FIG. 4 is a front view in elevation of the hanger system shown in FIG. 1, shown here with paintless dent repair tools stored therein.

FIG. 5 is a front view of the hanger element shown in FIG. 2 and FIG. 3 with a paintless dent repair tool stored therein.

FIG. 6 is a front-side view in elevation of the hanger system for dent repair tools according to an alternative embodiment of the invention.

FIG. 7 is a bottom view in elevation of the hanger element shown in FIG. 6.

### DETAILED DESCRIPTION OF THE INVENTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

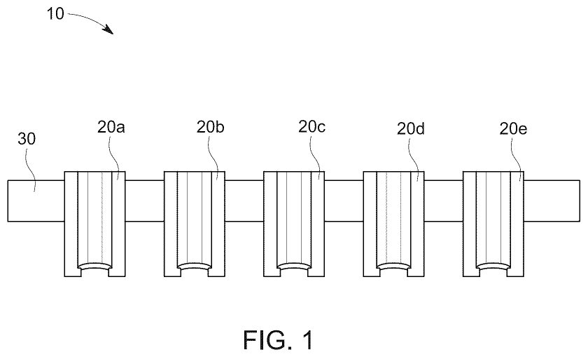

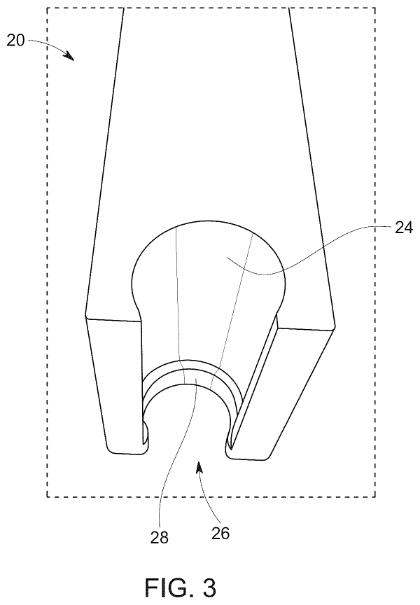

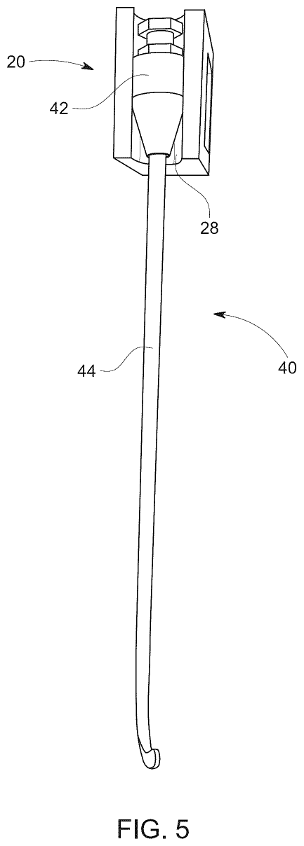

With reference to FIGS. 1 to 5, one presently preferred embodiment of the invention comprises a hanger system 10 for holding paintless dent repair (PDR) tools 40. The hanger system 10 includes one or more hanger elements 20a, 20b, 20c, 20d, 20e that are removably affixed to a support such as a square bar 30. The support bar 30 may be affixed to a movable cart (not shown) and is horizontally oriented for transporting the PDR tools 40. The support bar 30 is depicted as a square bar according to the preferred embodiment shown in the drawings. However, so long as the support bar 30 has the same shape and size as the opening 22 in each of the hanger elements 20, any polygonal shape will suffice. A cylindrical bar could be used, but polygonal bars are preferred as they prevent rotation of the hanger element 20 relative to the bar 30. The support bar 30 can be formed of any suitable rigid material. However, lightweight metals such as aluminum are preferred.

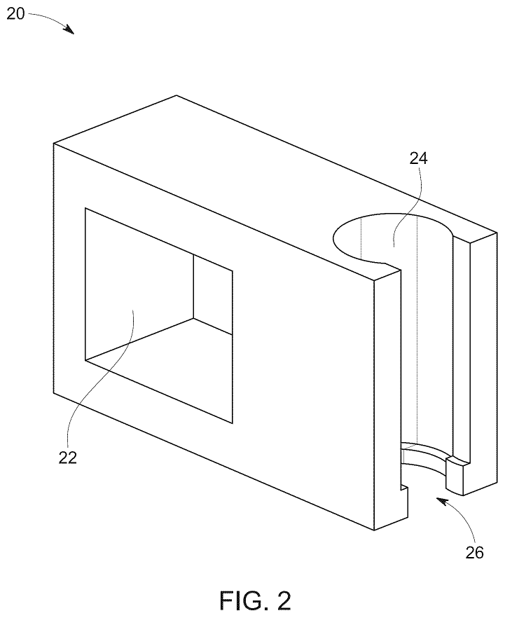

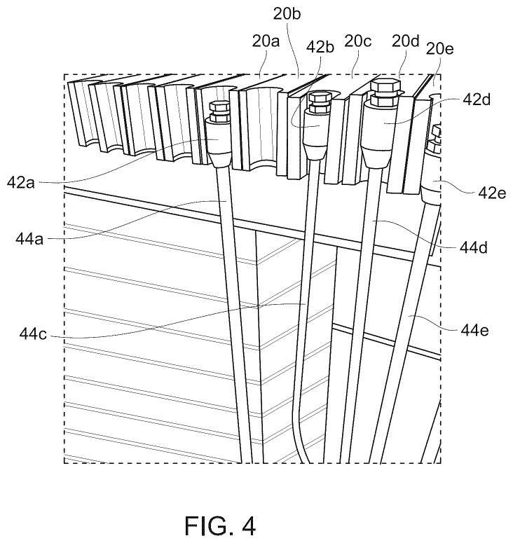

As best shown in FIG. 2, each hanger element 20 includes a polygonal shaped opening 22 that is designed to receive and frictionally engage an outer surface of the support bar 30. Each hanger element 22 is inserted onto the support bar 30 by sliding a free end of the support bar 30 through the opening 22 in the hanger element 20. The support bar 30 is designed to hold several hanger elements 20a, 20b, 20c, 20d, 20e as shown in FIG. 1 and FIG. 4. The hanger elements 20 can be spaced apart, as shown in FIG. 1, or they may be positioned in close proximity to neighboring hanger elements 20 as shown in FIG. 4.

Each hanger element 20 further includes a vertically oriented sleeve 24 for receiving a first end having a head 42 of a PDR tool 40. The sleeve 24 is generally cylindrically shaped and has a diameter that corresponds to the standard diameter(s) of the head 42 of a common PDR tool 40. The sleeve 24 can be tapered to accommodate heads of different sizes, and according to the preferred embodiment of the invention, is sized to accommodate a range of head sizes including those associated with some of the most popular tools available today having heads ranging from ¼″ to ½″. The sleeve 24 includes a vertical opening 26 at the front face of the hanger element 20. The vertical opening 26 is sized such that diameter of the shaft 44 of the PDR tool 40 is smaller than the opening allowing the shaft 44 to be inserted into the sleeve 24 without having to feed or thread the entire length of the PDR tool through the opening. A shoulder or ledge 28 is provided at the bottom edge of the sleeve 24. The ledge 28 prevents the PDR tool 40, particularly those having smaller diameter heads, from sliding all the way through the sleeve 24 and assists in holding the PDR tool 40 securely in place. A friction fit between the sleeve 24 and the head 42 of the PDR tool 40 is created when the PDR tool 40 is secured in the sleeve 24 providing further stability of the PDR tool 40 relative to the hanger system 10.

To secure a PDR tool 40 to the hanger system 10, the head 42 of the tool 40 is raised slightly above the upper surface of a selected hanger element 20. The shaft 44 of the tool 40 is then passed through the vertical opening 26 in the front face of the hanger element 20. The tool 40 is then lowered until the outer surface of the head 42 frictionally engages the surface of the sleeve 24, thereby securing the tool 40 in place. To remove a tool 40 from the hanger system 10, a person can grasp the shaft 44 of the tool 40 and raise it upwardly until the head 42 of the tool 40 has cleared the upper surface of the hanger element 20. The tool 40 can then be pulled toward the user, passing the shaft 44 through the vertical opening 26 to remove the tool 40 from the hanger system 10.

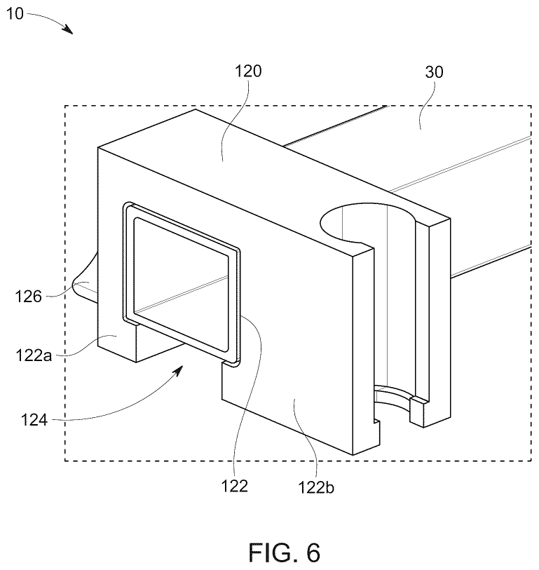

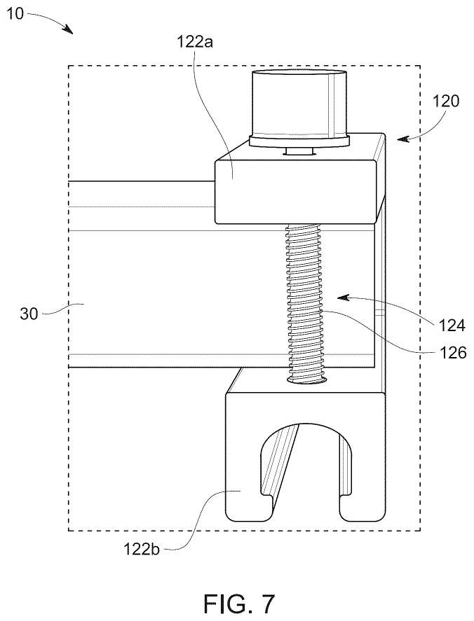

FIG. 6 and FIG. 7 show a hanger system 10 for holding paintless dent repair (PDR) tools 40 according to an alternative embodiment of the present invention. The hanger system 10 according to the alternative embodiment shown here includes one or more hanger elements 120 that are removably affixed to a support such as a square bar 30. Each hanger element 120 includes a polygonal shaped opening 122 that is designed to receive and frictionally engage an outer surface of the support bar 30. A slot 124 is provided in the bottom face of each hanger element 122 between opposing arms 122a, 122b of the hanger element. The hanger element 120 is installed onto the bar 30 by passing the bar 30 through the slot 124 and snapping the hanger element 120 into place on the bar 30. The hanger element 120 is formed from a semi-flexible plastic material such that the free ends 122a, 122b of the hanger element 120 on either side of the slot 124 are deflected outwardly as the hanger element 120 is pressed onto the bar 30 from above. The free ends 122a, 122b then snap back to their original position once they have cleared the bottom of the bar 30. A fastener, such as a threaded screw 126 can pass through an opening in the first arm 122a of the hanger element 120 and then threadably engages a threaded opening in the second arm 122b of the hanger element 120. The screw 126 can then be turned to pull the first arm 122a and second arm 122b toward one another, thereby securing the hanger element 120 to the bar 30.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

1. A hanger system configured to be affixed to a tool cart for hanging paintless dent repair tools comprising:
a. an elongated support bar having at least a first end affixed to an upper horizontal side rail of said tool cart;
b. at least one hanger element having a rigid, substantially non-deformable tool engaging means for removably receiving and securing a paintless dent repair tool by frictionally engaging a head of said paintless dent repair tool such that a shaft of the paintless dent repair tool extends downwardly from the hanger element, wherein the rigid, substantially non-deformable tool engaging means comprises a substantially cylindrical sleeve located at a front end of the body of said hanger element and having a fixed radius that is substantially equal to an outer radius of the head of the paintless dent repair tool to securely hold the paintless dent repair tool in place, said substantially cylindrical sleeve being substantially perpendicular to the support bar opening and having an opening in a front face of the body of the hanger element, said opening extending from a top end to a bottom end of the body for receiving a paintless dent repair tool; and
c. securing means for removably securing said at least one hanger element to said elongated support bar.

2. The hanger system according to claim 1, wherein said securing means comprises an opening extending through a body of the hanger element proximate to a rear end thereof, said opening sized to slidably engage an outer surface of the elongated support bar.

3. The hanger system according to claim 1 comprising a plurality of hanger elements slidably positioned on the elongated support bar.

4. (canceled)

5. The hanger system according to claim 1, further comprising, a shoulder extending inwardly into the substantially cylindrical sleeve proximate to a bottom end of the body of the hanger element.

6. A hanger system configured to be affixed to a tool cart for hanging paintless dent repair tools comprising:
a. an elongated support bar having at least a first end affixed to a an upper horizontal side rail of said tool cart;
b. at least one hanger element having a rigid, substantially non-deformable body with a front end and a rear end, said hanger element having a support bar opening extending through the body proximate to the rear end of the body, and a substantially cylindrical sleeve located at the front end of the body and having a fixed radius that is substantially equal to an outer radius of the head of the paintless dent repair tool to securely hold the paintless dent repair tool in place, said substantially cylindrical sleeve being substantially perpendicular to the support bar opening and having an opening in a front face of the body of the hanger element, said opening extending from a top end to a bottom end of the body, and a shoulder extending inwardly into the substantially cylindrical sleeve proximate to the bottom end of the body.

7. The hanger system according to claim 6 comprising a plurality of hanger elements slidably positioned on the elongated support bar.

8. The hanger system according to claim 6 wherein the support bar has a square cross-section and the support bar opening is square in shape and corresponds to the cross-section of the support bar in size and shape.

9. The hanger system according to claim 6 wherein the hanger element is formed from a plastic material selected from a group consisting of polypropylene, polyurethane, and PVC.

10. A method for securing a paintless dent repair tool in a hanger system configured to be affixed to a tool cart for hanging dent repair tools comprising the steps of:
a. positioning the paintless dent repair tool in front of a front face of a rigid, substantially non-deformable hanger element with a head of the paintless dent repair tool being positioned above a top surface of the hanger element;
b. passing a shaft of the paintless dent repair tool through an opening in the front face of the hanger element into a substantially cylindrical sleeve having a fixed radius that is substantially equal to an outer radius of the head of the paintless dent repair tool to securely hold the paintless dent repair tool in place, and said opening in the front face of the hanger element extending from the top surface of the hanger element to a bottom surface of the hanger element;
c. pulling the head of the paintless dent repair tool into the substantially cylindrical sleeve such that an outer surface of the head frictionally engages the surface of the substantially cylindrical sleeve without deforming the sleeve or the hanger element to securely hold the paintless dent repair tool in place.

11. The method for securing a paintless dent repair tool in a hanger system configured to be affixed to a tool cart for hanging dent repair tools according to claim 10 further comprising the step of continuing to pull the head of the paintless dent repair tool into the substantially cylindrical sleeve until a portion of the head engages a shoulder extending inwardly into the substantially cylindrical sleeve proximate to the bottom end of the hanger element.
